(19) United States
(12) Patent Application Publication
(10) Pub. No.: US 2015/0037630 A1
(43) Pub. Date: Feb. 5, 2015

(54) STORAGE BATTERY CABINET AND STORAGE BATTERY SYSTEM

(71) Applicant: Huawei Technologies Co., Ltd., Shenzhen (CN)

(72) Inventors: Hui Yu, Shenzhen (CN); Wen Fang, Shanghai (CN); Junxian Liu, Shenzhen (CN)

(21) Appl. No.: 14/516,244

(22) Filed: Oct. 16, 2014

Related U.S. Application Data
(63) Continuation of application No. PCT/CN2012/085272, filed on Nov. 26, 2012.

(30) Foreign Application Priority Data
Apr. 18, 2012 (CN) 201210114117.3

(51) Int. Cl. H01M 2/10; H01M 2/12

(52) U.S. Cl. CPC H01M 2/1077; H01M 2/12
USPC 429/71; 429/87

(57) ABSTRACT

Embodiments of the present invention provide a storage battery cabinet and storage battery system. One or more storage batteries are placed in a bottom space in the storage battery cabinet, through holes are separately opened in two opposite cabinet walls at a top of the storage battery cabinet, and a hydrogen evolution isolation component with openings is disposed in a space above the one or more storage batteries in the storage battery cabinet. The hydrogen evolution isolation component divides an internal space of the storage battery cabinet into an upper area and a lower area, and the hydrogen evolution isolation component is capable of allowing hydrogen generated by the one or more storage batteries to pass and discharge out of the storage battery cabinet from the through holes, and reducing air convection between the upper area and the lower area.

### CROSS-REFERENCE TO RELATED APPLICATION

This application is a continuation of International Application No. PCT/CN2012/085272, filed on Nov. 26, 2012, which claims priority to Chinese Patent Application No. 201210114117.3, filed on Apr. 18, 2012, both of which are hereby incorporated by reference in their entireties.

### TECHNICAL FIELD

The present invention relates to the field of electric energy, and in particular, to a storage battery cabinet and storage battery system.

### BACKGROUND

A storage battery is a common power supply apparatus in the industrial sector. An electrochemical reaction principle of the storage battery is to convert electric energy into chemical energy by charging the storage battery and store the chemical energy in the battery. Use of the storage battery is a discharge process, that is, the chemical energy in the storage battery is converted into electric energy and supplied to an external system. Charge and discharge processes of the storage battery are completed through electrochemical reactions. Electrochemical reaction formulas are as follows:

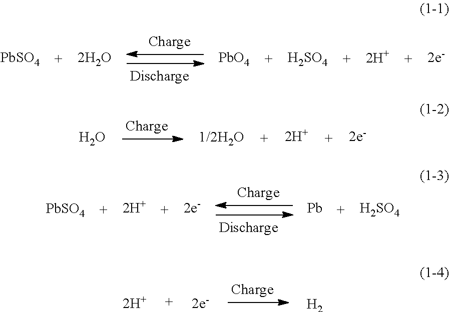

An electrochemical reaction formula (1-1) is a reaction occurring at a positive terminal, an electrochemical reaction formula (1-2) is a side reaction occurring at the positive terminal, an electrochemical reaction formula (1-3) is a reaction occurring at a negative terminal, and an electrochemical reaction formula (1-4) is a side reaction occurring at the negative terminal. It can be learnt from the foregoing electrochemical reactions that, the storage battery generates a by-product, hydrogen, during the charge process. In an enclosed space, when a volume of hydrogen mixed in air reaches 4%-74.2% of a total volume, a hydrogen explosion limit is reached. If an electrostatic spark is accidentally led in when the hydrogen reaches the explosion limit, a vicious accident such as an explosion may occur.

A storage battery is generally placed in a storage battery cabinet (also referred to as a storage battery compartment in certain cases, which is not strictly differentiated herein), and a space above the storage battery in the storage battery cabinet holds hydrogen released by the storage battery during the charge process. Therefore, for the storage battery cabinet, a favorable hydrogen discharge design is preferentially a safety performance design. In addition, the hydrogen discharge design cannot conflict with temperature control or an energy saving measure for the storage battery cabinet.

The prior art provides a hydrogen discharge solution for a storage battery cabinet, as shown in FIG. 1. The hydrogen discharge solution adds a hydrogen discharge tube 13 for each storage battery 12 in a storage battery cabinet 11. Hydrogen generated by a storage battery during a charge process is led out of the storage battery cabinet through the hydrogen discharge tube 13.

The hydrogen discharge solution for the storage battery cabinet shown in FIG. 1 may discharge the hydrogen in the storage battery cabinet. However, dedicated hydrogen discharge tubes are used, which may increase product design and/or manufacturing costs.

### SUMMARY

Embodiments of the present invention provide a storage battery cabinet and storage battery system for resolving a problem in the prior art that product design and/or manufacturing costs increase due to use of dedicated hydrogen discharge tubes.

An embodiment of the present invention provides a storage battery cabinet, where a bottom space in the storage battery cabinet is used to place one or more storage batteries, through holes are separately opened in two opposite cabinet walls at a top of the storage battery cabinet, and a hydrogen evolution isolation component with openings is disposed in a space above the storage battery in the storage battery cabinet. The hydrogen evolution isolation component divides an internal space of the storage battery cabinet into an upper area and a lower area, and the hydrogen evolution isolation component is capable of allowing hydrogen generated by the storage battery to pass and discharge out of the storage battery cabinet from the through holes, and reducing air convection between the upper area and the lower area.

An embodiment of the present invention further provides a storage battery system, including a storage battery cabinet and one or more storage batteries. A bottom space in the storage battery cabinet is used to place the storage battery, through holes are separately opened in two opposite cabinet walls at a top of the storage battery cabinet, and a hydrogen evolution isolation component with openings is disposed in a space above the storage battery in the storage battery cabinet. The hydrogen evolution isolation component divides an internal space of the storage battery cabinet into an upper area and a lower area, and the hydrogen evolution isolation component is capable of allowing hydrogen generated by the storage battery to pass and discharge out of the storage battery cabinet from the through holes, and reducing air convection between the upper area and the lower area.

It can be learnt from the foregoing embodiments of the present invention that, a hydrogen evolution isolation component with openings is added in a storage battery cabinet, which can allow hydrogen to pass and reduce air convection between an upper area and a lower area. In this way, hydrogen may enter the upper area from the lower area through the component because of small specific gravity and discharge from holes on both sides of the upper area. Meanwhile, it is difficult for air in the upper area (generally hotter than air in the lower area) to enter the lower area through the isolation component, thereby ensuring temperature stability in the storage battery cabinet. It may be seen that, after the hydrogen discharge solution is used, no dedicated hydrogen discharge tube is required, and instead, only a hydrogen evolution isolation component (design and installation costs of which are lower than those of a hydrogen discharge tube) needs to be disposed in the cabinet, and therefore the product cost is reduced.

### BRIEF DESCRIPTION OF THE DRAWINGS

To describe the technical solutions in the embodiments of the present invention more clearly, the following briefly introduces the accompanying drawings required for describing the prior art or the embodiments. Apparently, the accompanying drawings in the following description show merely some embodiments of the present invention, and a person skilled in the art may still derive other drawings from these accompanying drawings.

FIG. 1 is a schematic diagram of a hydrogen discharge solution for a storage battery cabinet according to the prior art;

FIG. 2a is a schematic structural diagram of a storage battery cabinet according to an embodiment of the present invention;

FIG. 2b is a schematic structural diagram of a storage battery cabinet according to another embodiment of the present invention;

FIG. 3 is a schematic structural diagram of a storage battery cabinet according to another embodiment of the present invention;

FIG. 4 is a schematic structural diagram of a storage battery cabinet according to another embodiment of the present invention;

FIG. 5a is a schematic structural diagram of a hydrogen evolution isolation component with openings according to an embodiment of the present invention;

FIG. 5b is a schematic structural diagram of a storage battery cabinet according to another embodiment of the present invention;

FIG. 6 is a temperature cloud diagram when a storage battery cabinet according to an embodiment of the present invention is used; and

FIG. 7 is a pressure cloud diagram when a storage battery cabinet according to an embodiment of the present invention is used.

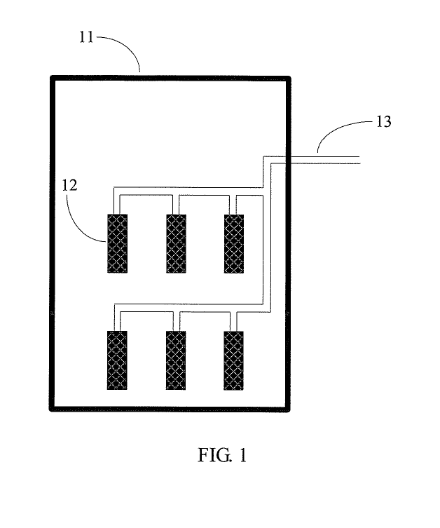

### DETAILED DESCRIPTION

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person skilled in the art based on the embodiments of the present invention shall fall within the protection scope of the present invention.

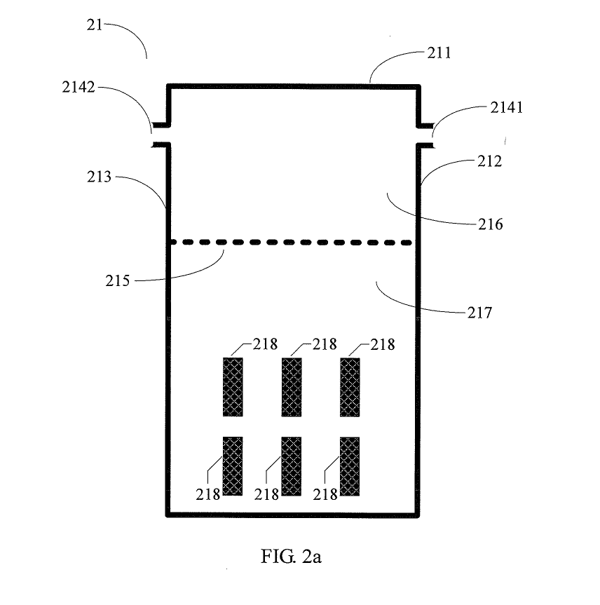

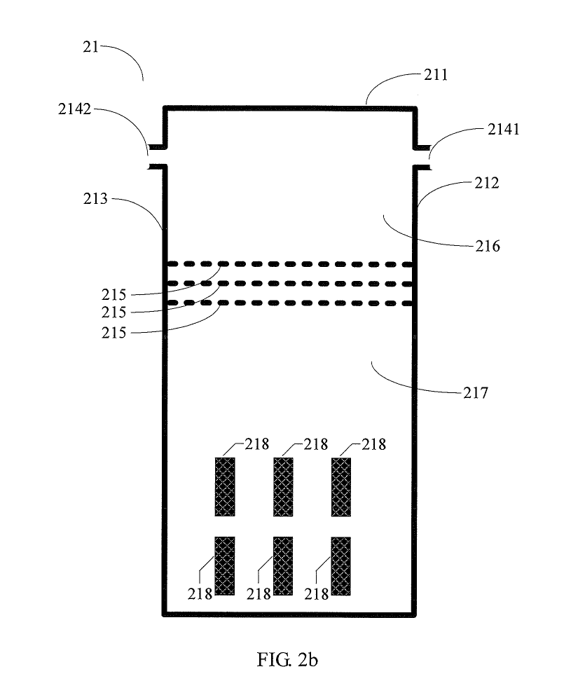

Reference may be made to FIG. 2a, which is a schematic structural diagram of a storage battery cabinet provided by an embodiment of the present invention. For ease of description, only parts related to the embodiment of the present invention are shown. As shown in FIG. 2a, a bottom space in a storage battery cabinet 21 is used to place one or more storage batteries 218, a through hole 2141 and a through hole 2142 are separately opened in two opposite cabinet walls 212 and 213 at a top 211 of the storage battery cabinet 21, and a hydrogen evolution isolation component 215 with openings (either with holes or seams, or both) is disposed in a space above the storage battery 218 in the storage battery cabinet. The hydrogen evolution isolation component 215 with openings is fixed on a side wall of the storage battery cabinet 21 and divides the space above the storage battery in the storage battery cabinet into an upper area 216 and a lower area 217. The upper area is also referred to as a hydrogen storage area 216, which is a hydrogen accumulation area. The lower area 217 is also referred to as a refrigeration area 217, in which air becomes cool because of an effect of refrigeration equipment, such as an air conditioner, in the storage battery cabinet 21. Density of hydrogen is lower than density of air, and the hydrogen evolution isolation component 215 has openings. Therefore, the hydrogen evolution isolation component 215 with openings can allow hydrogen generated by the storage battery to pass and discharge out of the storage battery cabinet from the through holes, and reduce convection between cold air in the refrigeration area 217 and air flowing into the hydrogen storage area 216 from the through hole 2141. Air convection is reduced. Therefore, it is difficult for the cold air in the refrigeration area 217 to perform heat exchange with the air flowing into the hydrogen storage area 216 from the through hole 2141. Specific gravity of hydrogen is smaller than specific gravity of the cold air in the refrigeration area 217. Therefore, hydrogen can naturally float up to the hydrogen storage area 216 from the refrigeration area 217 through the hydrogen evolution isolation component 215 with openings, whereas the cold air in the refrigeration area 217 naturally sinks. In another aspect, density of hydrogen is relatively small, permeability of hydrogen is higher than that of air, and the through hole 2141 and the through hole 2142 facilitate formation of air convection. The hydrogen floats up to the hydrogen storage area 216 and discharges out of the storage battery cabinet 21 from the through hole 2142 under a convection effect of the air flowing into the hydrogen storage area 216 from the through hole 2141.

It should be noted that, the foregoing “reduction” of air convection is not strictly limited. A person skilled in the art may select an appropriate “hydrogen evolution isolation component” according to an actual application scenario. For example, if an opening in the component is smaller, a “reduction” degree of air convection is larger, and an impact on the temperature in the lower area is naturally smaller; and conversely, if the opening in the component is larger, although air convection may also be “reduced”, because the opening is large, it is relatively easier for the air to enter the lower area from the upper area, and therefore, the impact on the temperature in the lower area is larger. Either manner is acceptable as long as it complies with system design indicators.

The hydrogen evolution isolation component may be a flat plate with dense small holes, a multi-layer flat plate with misaligned holes, a breathable film, or another structure that can implement a similar function (details are described in the following). To strengthen an effect, a plurality of these structures may be used. Reference may be made to FIG. 2a, which shows a hydrogen evolution isolation component that uses a specific structure. Reference may be made to FIG. 2b, which shows a hydrogen evolution isolation component that uses a plurality of specific structures (for example, a plurality of flat plates with dense holes). For ease of description, the “hydrogen evolution isolation component” in FIG. 2b may also be understood as a “hydrogen evolution isolation component group”, that is, including a plurality of the “hydrogen evolution isolation components” shown in FIG. 2a.

A service condition of a storage battery is strict, and an optimal operating temperature ranges from 15° C. to 25° C. When the temperature rises by 10° C., service life of the storage battery is reduced by 50%. Therefore, currently in the industry, an air conditioner is generally used in a storage battery cabinet for refrigeration and maintaining a constant temperature in the storage battery cabinet. In a hydrogen discharge apparatus for the storage battery cabinet shown in FIG. 2a or FIG. 2b, it is difficult for air flowing into the hydrogen storage area 216 from the through hole 2141 to pass through the hydrogen evolution isolation component 215 with openings or the hydrogen evolution isolation component group with openings. Therefore, no air disturbance is caused to cold air in the refrigeration area 217, that is, the hydrogen evolution isolation component 215 with openings or the hydrogen evolution isolation component group with openings prevents the cold air in the refrigeration area 217 from performing heat exchange with the air flowing from the through hole 2141, thereby ensuring temperature stability in the storage battery cabinet, reducing a load on an air conditioner in the storage battery cabinet, and reducing system energy consumption. Design and manufacturing costs of a hydrogen evolution isolation component are lower than design and manufacturing costs of a hydrogen discharge tube, and therefore the product cost is reduced.

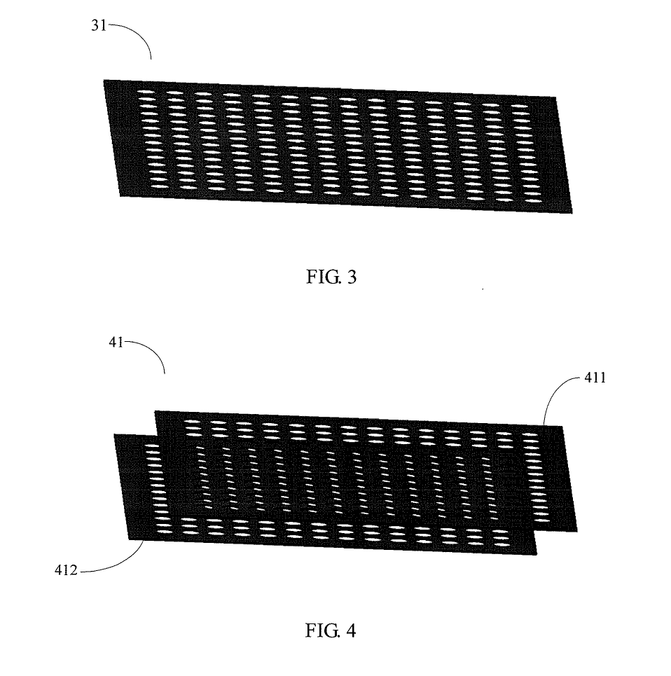

As an embodiment of the present invention, the hydrogen evolution isolation component 215 with openings may be a flat plate 31 with dense small holes or seams. FIG. 3 is a schematic diagram of the hydrogen evolution isolation component 215 with openings provided by the embodiment of the present invention. A size of a small hole or seam in the flat plate 31 is related to how many flat plates 31 are used in the storage battery cabinet 21. Generally, the small hole or seam in the flat plate 31 may be properly enlarged if a relatively large number of flat plates 31 are used, and the small hole or seam in the flat plate 31 may be properly narrowed if a relatively small number of flat plates 31 are used. For example, in a case where only one flat plate 31 is used, a diameter of the small hole of the flat plate 31 may generally range from 0.5 mm to 5 mm, and an area of the seam needs to be equivalent to an area of the small hole ranging from 0.5 mm to 5 mm (for example, a difference may be ±20%, and a proper size may be selected according to an actual situation as long as an expected effect may be achieved). Density of small holes or seams of the flat plate 31 is related to a size of the storage battery cabinet 21, the number of storage batteries 218, an area of the flat plate 31, and so on. Generally, as the size of the storage battery cabinet 21 increases, the number of storage batteries 218 increases, and the area of the flat plate 31 decreases, the small holes or seams in the flat plate 31 may be denser. Conversely, as the size of the storage battery cabinet 21 decreases, the number of storage batteries 218 decreases, and the area of the flat plate 31 increases, the small holes or seams in the flat plate 31 may be sparser.

To further strengthen a hydrogen evolution effect, in the embodiment of the present invention, the hydrogen evolution isolation component 215 with openings may be a double-layer flat plate. FIG. 4 is a schematic diagram of the hydrogen evolution isolation component 215 with openings provided by the embodiment of the present invention. As shown in FIG. 4, a gap exists between a first-layer flat plate 411 and a second-layer flat plate 412 of a double-layer flat plate 41, openings exist in the first-layer flat plate 411 and the second-layer flat plate 412, and the openings in the first-layer flat plate 411 are misaligned with the openings in the second-layer flat plate 412. The hydrogen evolution isolation component 215 with openings shown in FIG. 4 is double-layered, but specific gravity of hydrogen is smaller than that of air. Therefore, hydrogen can always float up to the hydrogen storage area 216 through openings in the first-layer flat plate 411 and the second-layer flat plate 412. However, even if air flowing into the hydrogen storage area 216 from the through hole 2141 passes through the first-layer flat plate 411, the air passing through the first-layer flat plate 411 may be blocked by the second-layer flat plate 412 and reflected back. Therefore, a technical effect brought by the double-layer flat plate 41 shown in FIG. 4 is relatively apparent.

As another embodiment of the present invention, the hydrogen evolution isolation component 215 with openings may be a panel with punched holes, and the hydrogen evolution isolation component 215 with openings may also be a breathable film.

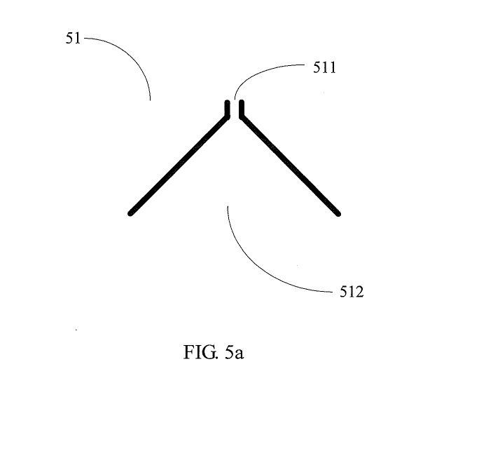

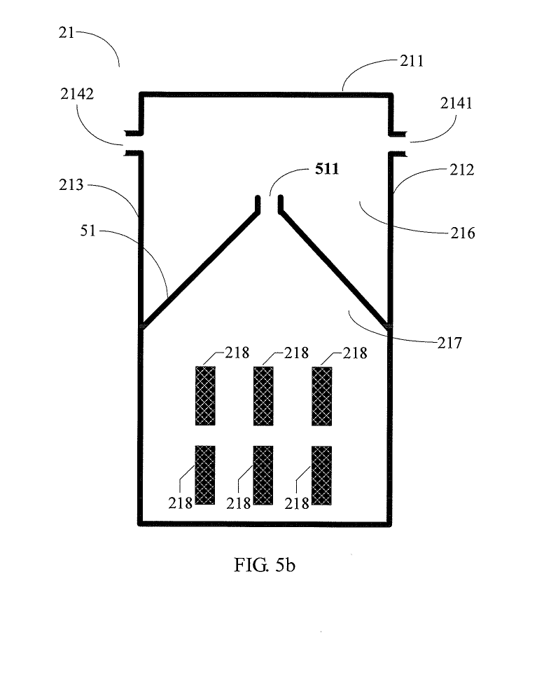

In another embodiment of the present invention, the hydrogen evolution isolation component 215 with openings may also be a “Λ”-shaped separator. FIG. 5a is a schematic diagram of the hydrogen evolution isolation component 215 with openings provided by the embodiment of the present invention. A small hole 511 is opened at a sharp corner of a “Λ”-shaped separator 51. The “Λ”-shaped separator 51 is fixed on a side wall of the storage battery cabinet 21, with its open end 512 facing downward, that is, the open end 512 of the “Λ”-shaped separator 51 is opposite to the storage battery 218 in the storage battery cabinet 21. FIG. 5b shows a hydrogen discharge apparatus for a storage battery cabinet provided by another embodiment of the present invention. Hydrogen in the refrigeration area 217 floats up, enters the open end 512 of the “Λ”-shaped separator 51, and passes through the small hole 511 at the sharp corner of the “Λ”-shaped separator 51, and enters the hydrogen storage area 216. In one aspect, because the small hole 511 at the sharp corner of the “Λ”-shaped separator 51 is relatively small, an amount of air that flows into the hydrogen storage area 216 from the through hole 2141 and can enter the refrigeration area 217 is also relatively small even without a hydrogen floating-up effect. In another aspect, the open end 512 of the “Λ”-shaped separator 51 is relatively large, high-pressure hydrogen can accumulate under the “Λ”-shaped separator 51, which largely prevents air in the hydrogen storage area 216 from entering the refrigeration area 217 and performing heat exchange with cold air in the refrigeration area 217.

To further strengthen a hydrogen evolution effect, in the embodiment of the present invention, the hydrogen evolution isolation component group with openings shown in FIG. 2b may be a group of breathable films, a group of panels with punched holes, a group of flat plates 31 with dense small holes or seams shown in FIG. 3, a group of double-layer flat plates 41 shown in FIG. 4, or a group of “Λ”-shaped separators 51 shown in FIG. 5a, that is, the hydrogen evolution isolation component group with openings shown in FIG. 2b may be at least two layers of breathable films, at least two panels with punched holes, at least two flat plates with dense small holes or seams, at least two double-layer flat plates 41, or at least two “Λ”-shaped separators 51.

The hydrogen evolution isolation component group with openings shown in FIG. 2b may also be any combination of a panel with punched holes, a breathable film, a flat plate 31 with dense small holes or seams shown in FIG. 3, a double-layer flat plate 41 shown in FIG. 4, or a “Λ”-shaped separator 51 shown in FIG. 5a. For example, the breathable film may be combined with the flat plate 31 with dense small holes or seams shown in FIG. 3 to constitute the hydrogen evolution isolation component group with openings shown in FIG. 2b. For another example, the double-layer flat plate 41 shown in FIG. 4 may be combined with the “Λ”-shaped separator 51 shown in FIG. 5a to constitute the hydrogen evolution isolation component group with openings shown in FIG. 2b, and so on.

The hydrogen evolution isolation component with openings or the hydrogen evolution isolation component group with openings is generally made of a metal material, and the metal material provides a good heat conductivity. Therefore, to prevent the heat conductivity of the metal material from providing convenience for cold air in the refrigeration area 217 to perform heat exchange with air flowing from the through hole 2141, in the embodiment of the present invention, a heat-insulation material may be disposed above or under the hydrogen evolution isolation component 215 with openings or the hydrogen evolution isolation component group with openings to reduce heat conduction of the metal material. The heat-insulation material may be heat-insulation sponge, and so on.

To strengthen air convection between the hydrogen storage area 216 and the outside of the storage battery cabinet 21, in the embodiment of the present invention, an air exhaust fan may further be disposed near the through hole 2141 and the through hole 2142 of the hydrogen discharge apparatus for the storage battery cabinet shown in FIG. 2.

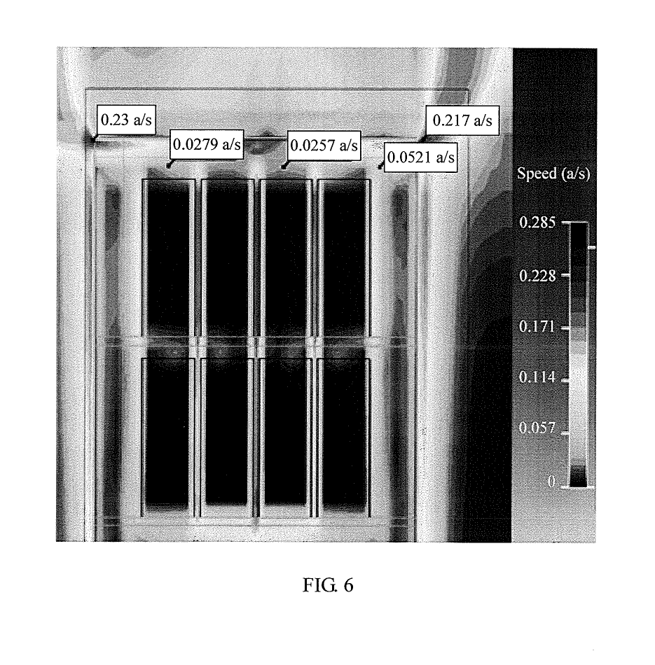

FIG. 6 is a temperature cloud diagram when a hydrogen discharge apparatus for a storage battery cabinet provided by an embodiment of the present invention is used. Air velocity of a natural cooling storage battery cabinet is very low. However, it may be seen from the temperature cloud diagram shown in FIG. 6 that, because the hydrogen discharge apparatus for the storage battery cabinet provided by the embodiment of the present invention is used, an air flow speed between the through hole 2141 and the through hole 2142 is increased, where the air flow speed is about 10 times a normal flow speed. The apparatus is similar to an expansion valve, and an air flow is expanded and ejected out of the hydrogen storage area 216, providing convenience for hydrogen to discharge out of the storage battery cabinet 21.

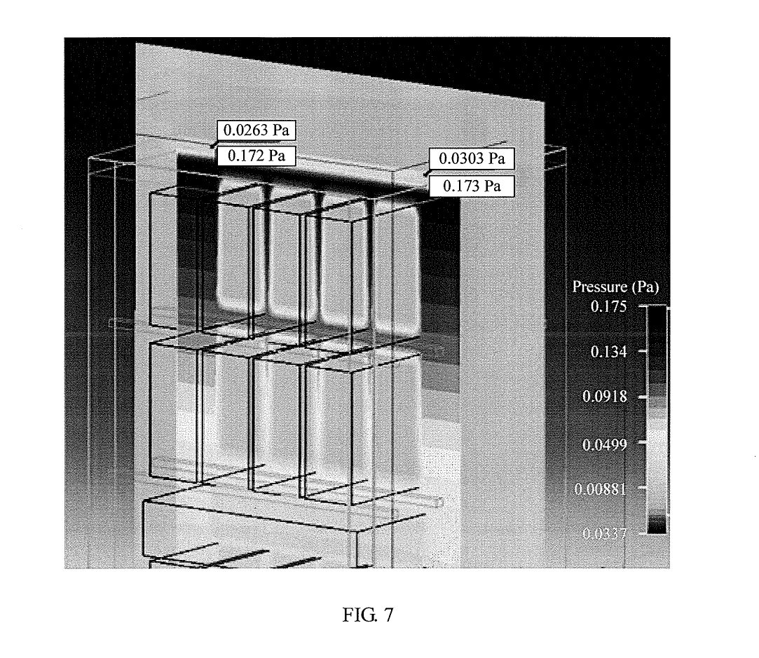

FIG. 7 is a pressure cloud diagram when a hydrogen discharge apparatus for a storage battery cabinet provided by an embodiment of the present invention is used. Positive pressure exists in the refrigeration area of the storage battery cabinet. In the hydrogen discharge apparatus for the storage battery cabinet provided by the embodiment of the present invention, pressure of the hydrogen storage area of the storage battery cabinet is less than pressure of the refrigeration area of the storage battery cabinet. From positive pressure to negative pressure and given that density of hydrogen is low, hydrogen may discharge out of the storage battery cabinet more easily.

Based on the foregoing embodiments, an embodiment of the present invention further provides a storage battery system, where the system includes a storage battery cabinet and one or more storage batteries shown in FIG. 2a to FIG. 4 and FIG. 5b. The storage battery is placed in a bottom space in the storage battery cabinet of the storage battery system, through holes are separately opened in two opposite cabinet walls at a top of the storage battery cabinet, and a hydrogen evolution isolation component with openings is disposed in a space above the storage battery in the storage battery cabinet. The hydrogen evolution isolation component divides an internal space of the storage battery cabinet into an upper area and a lower area, and the hydrogen evolution isolation component is capable of allowing hydrogen generated by the storage battery to pass and discharge out of the storage battery cabinet from the through holes, and reducing air convection between the upper area and the lower area.

To strengthen air convection in the upper area divided by the hydrogen evolution isolation component, in the foregoing storage battery system, an air exhaust fan is disposed near the through holes for strengthening air convection between the upper area and the outside of the storage battery cabinet.

For detailed introduction about the hydrogen evolution isolation component and other parts in this embodiment, reference may be made to the foregoing embodiments, and details are not repeatedly described herein.

The foregoing describes in detail a storage battery cabinet and storage battery system provided by the embodiments of the present invention. Although the principles and implementation manners of the present invention are described with reference to exemplary embodiments, descriptions of the foregoing embodiments are merely used to help understand a method of the present invention and its core idea. Meanwhile, a person of ordinary skill in the art can make various modifications and variations to the present invention in terms of the specific implementation manners and application scope according to the idea of the present invention. Therefore, the content described in the specification shall not be construed as a limitation on the present invention.

What is claimed is:

1. A storage battery cabinet, comprising:
a bottom space configured to receive one or more storage batteries;
through holes disposed in two opposite cabinet walls at a top of the storage battery cabinet; and
a hydrogen evolution isolation component with openings disposed in a space above the one or more storage batteries in the storage battery cabinet, wherein the hydrogen evolution isolation component divides an internal space of the storage battery cabinet into an upper area and a lower area and is capable of allowing hydrogen generated by the one or more storage batteries to pass and discharge out of the storage battery cabinet from the through holes, and reducing air convection between the upper area and the lower area.

2. The storage battery cabinet according to claim 1, wherein the hydrogen evolution isolation component comprises a flat plate with dense small holes or seams.

3. The storage battery cabinet according to claim 2, wherein a diameter of each small hole ranges from 0.5 mm to 5 mm, and an area of each seam is equivalent to an area of the small holes.

4. The storage battery cabinet according to claim 1, wherein the hydrogen evolution isolation component with openings comprises:
a double-layer flat plate with a gap between a first-layer flat plate and a second-layer flat plate of the double-layer flat plate, wherein openings in the first-layer flat plate are misaligned with openings in the second-layer flat plate.

5. The storage battery cabinet according to claim 1, wherein a heat-insulation material is disposed above or below the hydrogen evolution isolation component.

6. The storage battery cabinet according to claim 1, wherein an air exhaust fan is disposed near the through holes for strengthening air convection between the upper area and the outside of the storage battery cabinet.

7. The storage battery cabinet according to claim 1, wherein the hydrogen evolution isolation component comprises a panel with punched holes.

8. The storage battery cabinet according to claim 1, wherein the hydrogen evolution isolation component comprises a breathable film.

9. The storage battery cabinet according to claim 1, wherein the hydrogen evolution isolation component comprises a “Λ”-shaped separator having a small hole at a sharp corner of the “Λ”-shaped separator, and wherein the “Λ”-shaped separator is fixed on a side wall of the storage battery cabinet, with an open end facing downward.

10. A storage battery system, comprising:
a storage battery cabinet and one or more storage batteries, wherein a bottom space in the storage battery cabinet is configured to receive the one or more storage batteries, and through holes are separately opened in two opposite cabinet walls at a top of the storage battery cabinet; and
a hydrogen evolution isolation component with openings disposed in a space above the one or more storage batteries in the storage battery cabinet, wherein the hydrogen evolution isolation component divides an internal space of the storage battery cabinet into an upper area and a lower area, and the hydrogen evolution isolation component is capable of allowing hydrogen generated by the one or more storage batteries to pass and discharge out of the storage battery cabinet from the through holes, and reducing air convection between the upper area and the lower area.

11. The storage battery system according to claim 10, wherein the hydrogen evolution isolation component comprises a flat plate with dense small holes or seams.

12. The storage battery system according to claim 11, wherein a diameter of each small hole ranges from 0.5 mm to 5 mm, and an area of the seam is equivalent to an area of the small hole.

13. The storage battery system according to claim 10, wherein the hydrogen evolution isolation component comprises:
a double-layer flat plate having a gap between a first-layer flat plate and a second-layer flat plate of the double-layer flat plate, wherein openings in the first-layer flat plate are misaligned with openings in the second-layer flat plate.

14. The storage battery system according to claim 10, wherein a heat-insulation material is disposed above or below the hydrogen evolution isolation component.

15. The storage battery system according to claim 10, wherein an air exhaust fan is disposed near the through holes for strengthening air convection between the upper area and the outside of the storage battery cabinet.

16. The storage battery system according to claim 10, wherein the hydrogen evolution isolation component comprises a panel with punched holes.

17. The storage battery system according to claim 10, wherein the hydrogen evolution isolation component comprises a breathable film.

18. The storage battery system according to claim 10, wherein the hydrogen evolution isolation component comprises a “Λ”-shaped separator having a small hole opened at a sharp corner of the “Λ”-shaped separator, and wherein the “Λ”-shaped separator is fixed on a side wall of the storage battery cabinet, with an open end facing downward.
